(19) United States
(12) Patent Application Publication
(10) Pub. No.: US 2015/0123454 A1
(43) Pub. Date: May 7, 2015

(54) Modular Wheel Design for Use with Motor Vehicles

(71) Applicant: Parke Joseph Bishop, JR., Elverson, PA (US)

(72) Inventor: Parke Joseph Bishop, JR., Elverson, PA (US)

(21) Appl. No.: 14/512,265

(22) Filed: Oct. 10, 2014

Related U.S. Application Data
(60) Provisional application No. 61/901,227, filed on Nov. 7, 2013.

(51) Int. Cl. B60B 7/04; B60B 31/00; B60B 7/06

(52) U.S. Cl. CPC B60B 7/04; B60B 7/06; B60B 31/00; B60B 2900/351; B60B 2900/572; B60B 2320/10; B60Y 2200/10
USPC 301/37.102; 29/894.3

(57) ABSTRACT

A modular or component wheel design, having interchangeable elements, for use within the automotive, motorcycle, and golf cart industry is disclosed. The wheel design components comprise a plurality of individual blade, or alternatively one complete blade runner component that is secured to a rim component through a common central hub, and a plurality of bolts positioned along the outer surface of the rim. For decorative purposes, the wheel base lug holes can be placed within the rim's spoke design and can then be covered by a one piece blade runner or by several individual blade runners. The base rim is designed to available in a range of standard and fixed sizes, and with a variety of offsets. The bolt-on blade runners, central hub and bolts may be manufactured in a variety of patterns, finishes and materials such that the wheel design and ornamental features may be readily altered for individual appearances.

### FIELD OF THE INVENTION

The present invention generally relates to motor vehicle wheels and wheel rim designs, and more particularly relates to a wheel rim design comprising a plurality of interchangeable components that allow the user to customize the ornamental look of the wheel and wheel rim without removal of the rim from the vehicle or tire from the rim. The wheel rim system includes a standard size wheel rim having normal lug nut locations, a plurality of blade runners that are secured to the wheel rim using a central hub element and a plurality of fasteners or bolts that attach proximally to the circumferential edge of the rim. The wheel rim can be manufactured from a variety of materials including aluminum or steel for structural integrity. The wheel rim components, including the blade runners, central hub element and plurality of fasteners may be manufactured from a variety of materials including aluminum, steel, plastic, fiberglass, or other composite type materials. The surface finish of the several components can include one or more of powder coating, polished aluminum or steel, different color paint, or chrome plating.

### BACKGROUND OF THE INVENTION

Since the very first wheels were designed for motor vehicles, the appearance or look of the wheels have been modified and improved for structural and aesthetic reasons. For decades, various efforts and designs have been produced to improve the appearance of original equipment manufacturer (“OEM”) standard wheels. A desire to distinguish or customize the look of a vehicle, has been on the minds of vehicle owners probably since the first motor vehicle was purchased. However, the effort to remove OEM wheels in order to clean, paint or customize them is difficult, time consuming, and often times very expensive.

Aftermarket wheel designs are available, and have created a substantial market accessible to and used by vehicle owners. Such wheel designs include not only a selection of alloy, chrome, and other material designs, but in addition to different materials, such aftermarket designs include different wheel rim sizes, as well as different structural elements, spokes and spinners allowing users to have a unique wheel design for their vehicle. All of these designs are, however, fixed in design and look, and thus provide a single ornamental design and look. Such aftermarket replacement wheels are then often resold or discarded when they are out of date or if the consumer wants to change the design or look. Changing wheel designs with aftermarket products can be very expensive. Moreover, many aftermarket wheel designs are not easily maintained. Indeed, a separate wheel cleaning product industry has developed primarily to provide products to make cleaning of the wheels from dirt and brake dust a little easier.

Moreover, certain OEM and aftermarket wheel designs use or include plastic pieces or caps or a wheel cover that is non-securely fastened to the wheel rim. Such pieces often are dislodged and fall off as a result of road hazards (e.g., potholes) and/or improper installation.

What is needed is a vehicle wheel design that allows for after purchase customization or redesign such that the look and appearance of the wheel can be readily modified without purchasing a new wheel design. Such a wheel design should allow for customization where the customizable pieces are securely fastened to the wheel rim.

### SUMMARY OF THE INVENTION

The above described problems that are inadequately or incompletely resolved by prior art designs, are addressed and solved by the present invention.

A preferred embodiment of the invention is a modular wheel for use with motor vehicles, comprising a base wheel hub having a center section, and a rim section; at least one blade runner, having a proximal rim end, and a distal center hub end; a central hub element attachable to said center section of said base wheel hub and securing said distal center hub end of said at least one blade runner to said base wheel hub; and a plurality of fasteners attachable to said rim section of said base wheel hub and securing said proximal rim end of said at least one blade runner to said base wheel hub.

Another preferred embodiment of the invention is a system of modular wheel components for use with motor vehicles, comprising a base wheel hub having a center hub section, and an outer rim section; at least one blade runner, having a rim end, and a center hub end; a central hub element attachable to said center hub section of said base wheel hub and securing said center hub end of said at least one blade runner to said base wheel hub; and a plurality of fasteners attachable to said outer rim section of said base wheel hub and securing said rim end of said at least one blade runner to said base wheel hub.

A further aspect of the invention is a method for interchanging modular wheel components, wherein said modular wheel components are use with motor vehicles, and further wherein said modular wheel components comprise a base wheel hub having a center hub section, and an outer rim section; at least one blade runner having a rim end and a center hub end; a hub fastening element; and a plurality of fasteners, said method comprising the steps of (a) attaching said center hub end of said at least one blade runner to said center hub section of said base wheel hub using said hub fastening element; and (b) attaching said rim end of said at least one blade runner to said outer rim section of said base wheel hub using said plurality of fasteners.

The invention will be best understood by a review of the following detailed description of preferred embodiments in conjunction with the drawings briefly described below.

### BRIEF DESCRIPTION OF THE DRAWINGS

For the purposes of illustrating the invention, the attached drawings show several embodiments that are presently preferred. However, it should be understood that the invention is not limited to the precise arrangement and instrumentality shown in the accompanying drawings.

FIG. 1: is a side view of an exemplary embodiment of the component parts used in the modular wheel design;

FIG. 2: is a top view of an exemplary embodiment of a single blade runner showing three fastener holes;

FIG. 2A: is a front cut-away view of an exemplary embodiment of a wheel hub showing the rolled bead tire seat;

FIG. 3: is a side view of an exemplary embodiment of the wheel hub, a central hub fastening, and a variety of blade runner designs;

FIG. 4: is a side view of an exemplary embodiment of a fully assembled modular wheel showing five blade runners securely fastened to the standard base wheel hub; and

FIG. 5: is a top view of an exemplary embodiment of a vehicle steering wheel that may use similar interchangeable wheel hub components.

### DETAILED DESCRIPTION OF PREFERRED EMBODIMENTS

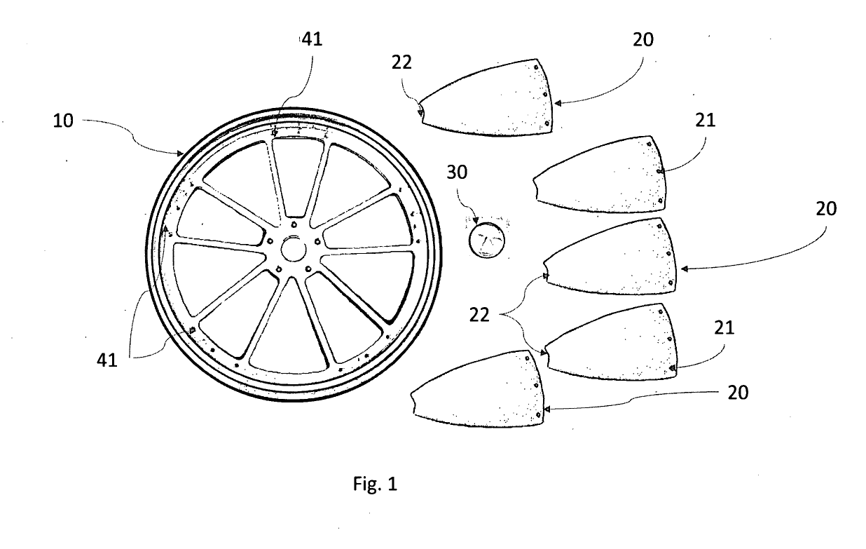

A modular wheel having interchangeable components for use within the automotive, motorcycle, all-terrain vehicle, and golf cart industries is disclosed. The basic modular wheel design components, as illustrated in an embodiment in FIG. 1, comprise a standard sized wheel rim 10, several individual blade runners 20, a common central hub nut 30, and a plurality of fasteners or bolts 40. Each of these components may be offered together as a complete system or set, or may be individually commercialized and assembled and used by the end user. It is important to note that the blade runners 20, common central hub nut 30, and plurality of fasteners or bolts 40 are used for cosmetic or decorative purposes only, and do not form part of the wheel structure or load bearing elements of the wheel rim 10.

The assembly of the modular wheel components is designed for easy use and assembly by most any mechanically inclined end user, and still secure and redundant enough to ensure the components are not able to easily release or fall off during normal operation. More particularly, the wheel rim 10 may be first mounted to the vehicle using the standard lug nuts attached to the lug bolts extending through the wheel rim 10 lug nut holes 11.

Then the assembly of the components entails placing the blade runners 20 in position on the wheel rim 10 and fastening or anchoring each blade runner 20 to the wheel rim 10 using a plurality of fasteners or bolts 40. The fasteners or bolts 40 are placed or screwed into a plurality of holes 21 formed along the outer edge of each blade runner 20, as illustrated in FIG. 1. The fasteners or bolts 40 extend through the blade runner 20 and the blade runner holes 21 to securely screw into the wheel rim holes 41 formed along the outer edge of the wheel rim 10. Appropriate torque levels may be set to ensure that the fasteners or bolts 40 remain securely in place in the wheel rim 10 and thereby ensure each blade runner remains rigidly attached to the wheel rim 10. By way of one example, the bolts 40 may be manufactured as No. 9, 12-point bolts.

While the embodiment illustrated in FIG. 1 show each blade runner 20 having three blade runner holes 21 formed in each blade runner 20, in other embodiments, the number of blade runner holes 21 can be one or more. By having more than a single blade runner hole 21 in each blade runner, redundancy and security of the assembly is enhanced.

Next, the common central hub nut 30 is placed or screwed into wheel rim 10 using wheel rim hole 31 such that the central hub nut 30 clamps the center edge 22 of each individual blade runner 20. In a preferred embodiment (not shown in the Figures), the central hub nut 30 has a cut out section that mates with an opposite flange or cut out section near the center edge 22 of each blade runner 20. Such intermeshing of flange or cut out sections between the central hub nut 30 and each blade runner 22 ensures a solid and secure retention of each blade runner 22 to the wheel rim 30.

Similar to the fasteners or bolts 40, an appropriate torque level may be set to ensure that the central hub nut 30 remains securely in place in the wheel rim 10 and thereby further ensuring that each blade runner 20, remains firmly attached to the wheel rim 10. In another embodiment, not illustrated, instead of a plurality of individual blade runners, a single blade runner component could be manufactured. For such a single blade runner component, the central hub nut 30 extends through the hole formed in the center of the single blade runner component and into the wheel rim hole 31. In another embodiment, the central hub nut 30 could be formed as a locking nut with a key lock mechanism, or with a unique shaped design within the hub nut 30, so that only the owner having the key or a wrench with the matching unique shaped design can readily remove the hub nut 30.

With respect to materials that may be used for each of the modular component pieces, the wheel rim 10 may be offered in aluminum alloy, cast aluminum or steel. Use of such materials generally ensures that the structural integrity of the wheel rim 10 is designed to meet all necessary governmental and safety regulations. The blade runners 20, central hub 30 and bolts 40 may be manufactured using similar materials, including aluminum alloy, cast aluminum, billet aluminum, or steel, or because such components are not load bearing, they could be manufactured using wood, ABS plastic and/or fiberglass. Further ornamentation and decorative finish can be incorporated into each of the components by using different surface finishes, which may include by way of example powder coating, polished, painted finish, or chrome plating. By way of example, the blade runners 20 and center hub 30 may be manufactured using different finishes including polished aluminum, powder coating in any color, plated in chrome, silver or gold in order to match certain features, or to accent the base wheel rim 10. The variation of material, surface finish, and color is as wide as the user's imagination.

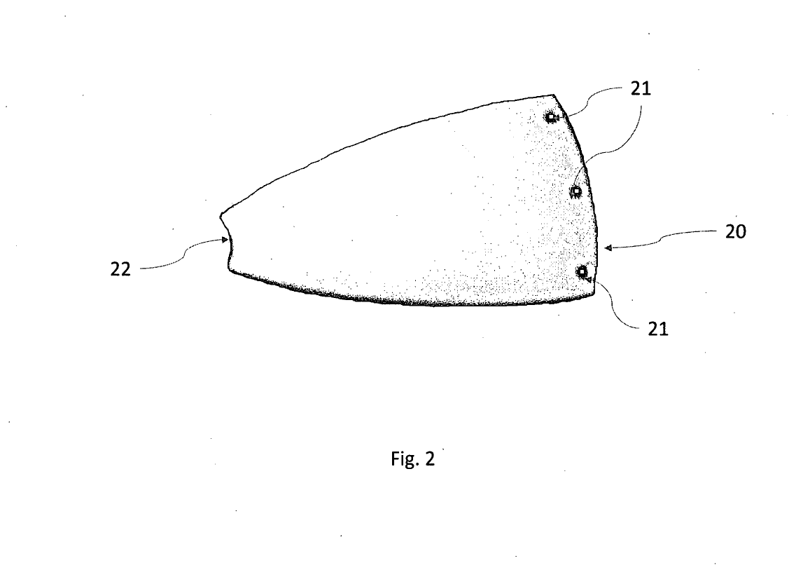

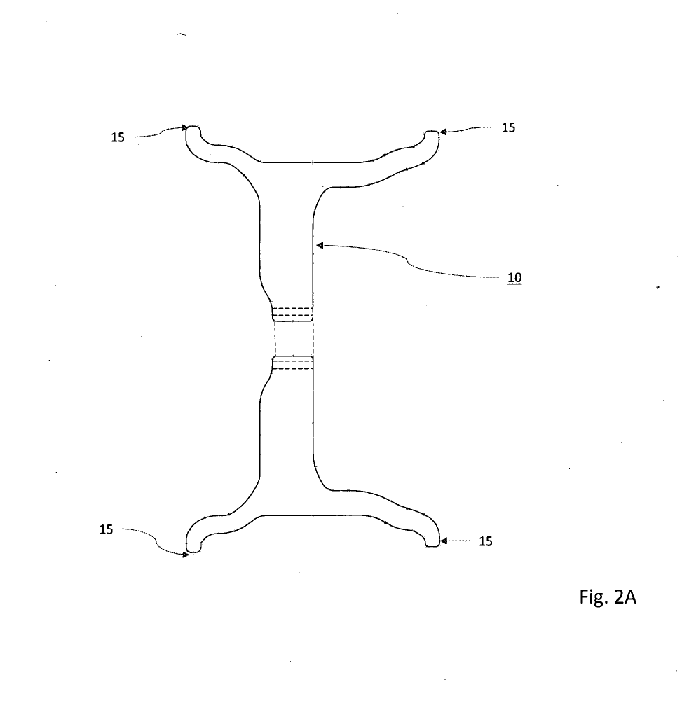

By way of further description, and as shown in FIG. 2A, the wheel rim 10 is a standard fit custom rim with a rolled bead 15 tire seat that may be offered in cast/billet aluminum or steel. More specifically, as shown in FIG. 2A, the base wheel rim 10 has a rolled lip 15 for the tire bead seat for a seamless appearance. The base wheel rim 10 may be manufactured with a standard five-spoke design, similar to that shown in FIG. 1, for use with automobiles, light duty trucks, sport utility vehicles (“SUV”), all-terrain vehicles (“ATV”), golf carts and other similar motor vehicles. As noted above, the base wheel rim 10 is fastened to the vehicle by standard lug nuts attached to the vehicle lug bolts extending through the base wheel rim lug holes 11 that may be centered in between each of the spokes for stability and load-bearing support. For application of the modular wheel design for use with motorcycles, the standard design of the wheel base rim would be secured by a standard motorcycle shaft. Also for the motorcycle embodiment, given that the wheel hub 10 is viewable from both sides, the blade runners 20 are mountable to both sides of the wheel hub 10. In different embodiments for a motorcycle, a three spoke or five spoke design may be used, with respective three blade runners 20 or five blade runners being attached to the wheel hub 10.

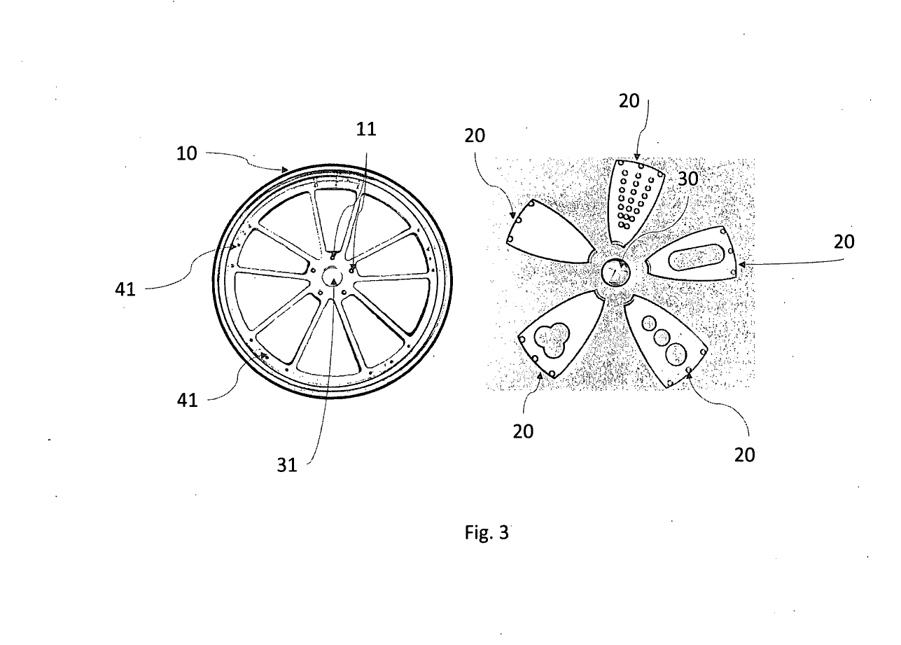

The blade runners 20, as shown in FIGS. 1 and 2, may be made as described above from cast aluminum, billet aluminum, wood, composites, Kevlar, ABS plastic, or steel. While aluminum, steel, or Kevlar would likely be more durable than some other materials, because the blade runners 20 are not load bearing, other materials, such as wood may be used for aesthetic purposes. The blade runners 20 may also be offered with various finishes including polished aluminum, powder coating in any color, plated in chrome, silver or gold. Given the ornamental design element of the blade runners 20, in a preferred embodiment of the present invention, they may be offered, as shown in FIG. 3, having various designs, engravings, cutouts, or other etchings that are standard or custom manufactured. By way of specific example, the engravings or cutouts on the blade runners 20 may include vehicle manufacturer name, loved-ones name, sports team names, and so on. In various designs, the blade runners 20 may also be offered having a flat or raised appearance.

An objective of the disclosed design of modular wheel components, is that the blade runners 20, center hub 30, and blade runner bolts 40 may be quickly changed allowing for easily changed wheel appearances without having to remove the rim and tire from the vehicle or the tire from the wheel rim. This allows the user to quickly obtain a new look for his or her vehicle at a low cost, and with little effort or time investment to make that change.

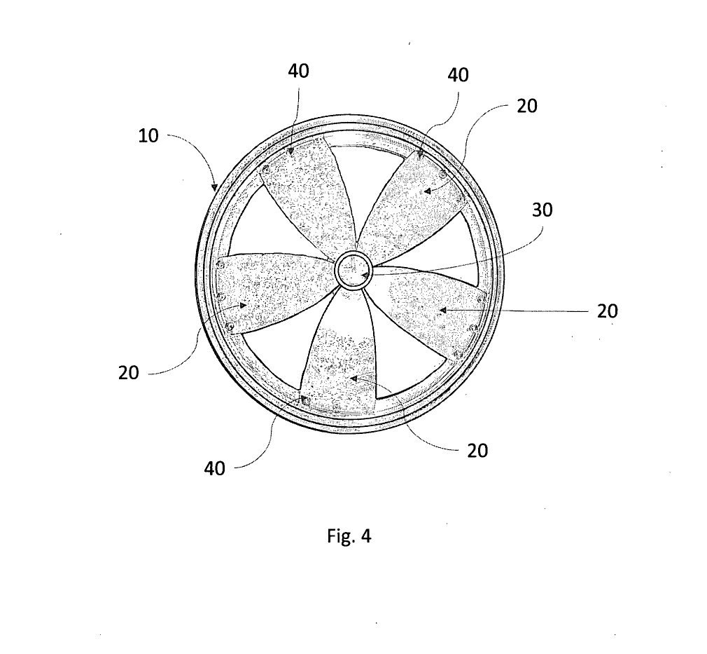

For decorative purposes, the lug nut holes 11 may be positioned within the wheel rim's spoke such that the lug nuts are covered by a one piece blade runner 20 or several individual blade runners 20, as illustrated in FIG. 4. Alternatively, in another embodiment, the position of the lug nuts may be incorporated into the blade runner 20 design. The base wheel rim 10 is generally a standard size and fixed for the intended vehicle, however as with current vehicles, the wheel rim 10 used with the inventive modular design can be manufactured in different sizes and rim offsets.

As disclosed, the inventive custom wheel design improves upon current OEM and aftermarket wheels by creating a set of interchangeable component parts that can be easily installed to completely change the design and look of the existing base wheel. Such a change in the design can be accomplished without having to remove the wheel from the vehicle. As shown and described, even though the components may be readily removed and replaced, each of the components are designed to be fastened to the base wheel rim 10 that is safe and secure once properly installed.

Moreover, the inventive wheel design can drastically reduce manufacturing costs by offering a standard base wheel design with a wide variety of looks simply by using different blade runners 20, instead of having entire new base wheel formed with the new look. Such modular design saves the wheel manufacturer excess material waste when using cast aluminum instead of billet aluminum (where, by example, seventy percent of the material is wasted after machine processing).

Considering the retail distribution channel of sale, using the inventive modular wheel design, wheel inventory is simplified by only needing a series of standard base rims in various sizes and offsets. The primary inventory or stock will consist of the individual blade runners 20, in various designs, finishes, and colors, and the central hubs 30 and bolts 40, also in various finishes and colors. Because the blade runners 20, central hubs 30 and bolts 40 can be manufactured in various finishes, the warehouse space necessary to carry a wide variety of wheel look designs is substantially reduced, all without sacrificing design availability to customers.

More particularly, in view of the modular design, the consumer may purchase a single base wheel rim 10 and then purchase multiple different blade runner 20, center hub 30 and bolt 40 designs thereby providing the consumer with a variety of aesthetic wheel looks using the single wheel rim 10. Such a complete change in the look of the vehicle wheel is simply and readily accomplished, without having to dismount the tire or removing the wheel from the vehicle, by changing one or more blade runners 20 and/or the center hub 30.

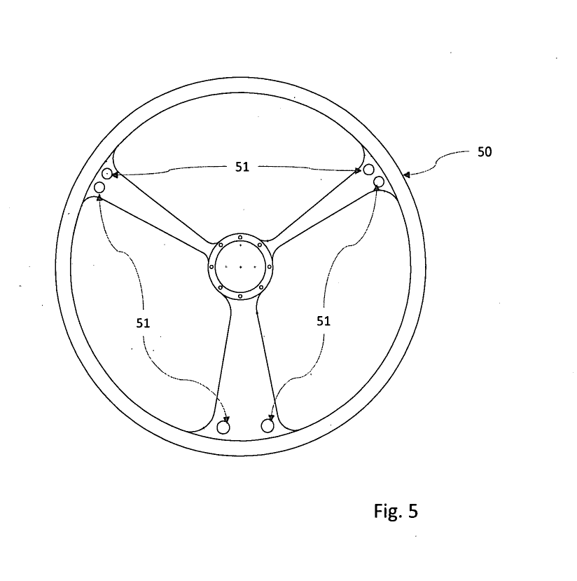

In a further preferred embodiment, the modular wheel design may also include a matching steering wheel 50, as illustrated in FIG. 5, or more specifically that matches the road wheels of the vehicle. In other words, the vehicle steering wheel 50 may be manufactured and customized to match or be similar the plating and center hub design of the vehicle wheels or can be customized with a different look and sold separately. A plurality of steering wheel rim holes 51 are formed along the outer each of the inner diameter of the steering wheel 50 to permit the blade runners 20 to be attached to the steering wheel 50.

Certain preferred embodiments and examples of the inventive modular wheel design for use with motor vehicles have been described herein and in the attached materials. It is to be understood that various modifications may be made to these described embodiments without departing from the spirit and scope of the invention.

More particularly while certain exemplary embodiments of the inventive modular wheel design have been disclosed and described, there may be other design architectures, and component elements that provide for alternative wheel design structures that provide other means for interchanging the aesthetic wheel design, for example by using different materials for the various component pieces. Such alternative materials and designs may use similar design elements, and result in a similar construction as disclosed herein.

All such equivalent configurations, modifications and other embodiments are intended to be, and are deemed within the scope of the above description and within the following claims. Those having ordinary skill in the art and access to the teachings provided herein will recognize additional modifications, applications, embodiments and substitution of equivalents all of which are within the scope of the invention. Accordingly, the invention is not to be considered as limited by the specific foregoing description.

what I claim as my invention is:

1. A modular wheel for use with motor vehicles, comprising:
a base wheel hub having a center section, and a rim section;
at least one blade runner, having a proximal rim end, and a distal center hub end;
a central hub element attachable to said center section of said base wheel hub and securing said distal center hub end of said at least one blade runner to said base wheel hub; and
a plurality of fasteners attachable to said rim section of said base wheel hub and securing said proximal rim end of said at least one blade runner to said base wheel hub.

2. The modular wheel for use with motor vehicles, as described in claim 1, wherein said base wheel hub further has a plurality of spoke elements, and an associated same number of blade runners attachable along said respective plurality of base wheel hub spoke elements.

3. The modular wheel for use with motor vehicles, as described in claim 1, wherein said base wheel hub has five spoke elements and there are five blade runners attachable along said respective base wheel hub spoke elements.

4. The modular wheel for use with motor vehicles, as described in claim 1, wherein said base wheel hub is made of a material consisting of at least one of steel, aluminum, or magnesium.

5. The modular wheel for use with motor vehicles, as described in claim 1, wherein said at least one blade runner, said central hub element, and said plurality of fasteners are made of a material consisting of at least one of steel, aluminum, or magnesium.

6. The modular wheel for use with motor vehicles, as described in claim 1, wherein said at least one blade runner and said plurality of fasteners are made of brushed aluminum.

7. The modular wheel for use with motor vehicles, as described in claim 1, wherein said at least one blade runner, said central hub element, and said plurality of fasteners have a brushed chrome surface finish.

8. The modular wheel for use with motor vehicles, as described in claim 1, wherein said at least one blade runner, said central hub element, and said plurality of fasteners have a painted surface finish.

9. The modular wheel for use with motor vehicles, as described in claim 1, wherein said modular wheel is configured for use on a motorcycle.

10. The modular wheel for use with motor vehicles, as described in claim 1, wherein said modular wheel is used on an all-terrain vehicle.

11. The modular wheel for use with motor vehicles, as described in claim 1, wherein said modular wheel is used as a steering wheel of said motor vehicle.

12. The modular wheel for use with motor vehicles, as described in claim 1, wherein said modular wheel is used as a steering wheel of a boat.

13. A system of modular wheel components for use with motor vehicles, comprising:
a base wheel hub having a center hub section, and an outer rim section;
at least one blade runner, having a rim end, and a center hub end;
a central hub element attachable to said center hub section of said base wheel hub and securing said center hub end of said at least one blade runner to said base wheel hub; and
a plurality of fasteners attachable to said outer rim section of said base wheel hub and securing said rim end of said at least one blade runner to said base wheel hub.

14. The system of modular wheel components for use with motor vehicles, as described in claim 13, wherein said base wheel hub further has a plurality of spoke elements, and an associated same number of blade runners attachable along said respective plurality of base wheel hub spoke elements.

15. The system of modular wheel components for use with motor vehicles, as described in claim 13, wherein said base wheel hub is made of a material consisting of at least one of steel, aluminum, or magnesium.

16. The system of modular wheel components for use with motor vehicles, as described in claim 13, wherein said at least one blade runner, said central hub element, and said plurality of fasteners are made of a material consisting of at least one of steel, aluminum, or magnesium.

17. The system of modular wheel components for use with motor vehicles, as described in claim 13, wherein said modular wheel components are used on a motorcycle.

18. The system of modular wheel components for use with motor vehicles, as described in claim 13, wherein said modular wheel components are used on an all-terrain vehicle.

19. The system of modular wheel components for use with motor vehicles, as described in claim 13, wherein said modular wheel components are used as a steering wheel of said motor vehicle.

20. A method for interchanging modular wheel components, wherein said modular wheel components are used with motor vehicles, and further wherein said modular wheel components comprise a base wheel hub having a center hub section, and an outer rim section; at least one blade runner having a rim end and a center hub end; a hub fastening element; and a plurality of fasteners, said method comprising the steps of:
a. attaching said center hub end of said at least one blade runner to said center hub section of said base wheel hub using said hub fastening element; and
b. attaching said rim end of said at least one blade runner to said outer rim section of said base wheel hub using said plurality of fasteners.
